(19) United States
(12) Patent Application Publication
(10) Pub. No.: US 2011/0219319 A1
(43) Pub. Date: Sep. 8, 2011

(54) SYSTEM AND METHOD FOR KNOWLEDGE-BASED INPUT IN A BROWSER

(75) Inventors: Yi Chen, Beijing (CN); Yuliang He, Beijing (CN)

(73) Assignee: LONSOU (BEIJING) TECHNOLOGIES CO., LTD., Beijing (CN)

(21) Appl. No.: 12/995,997

(22) PCT Filed: Apr. 24, 2008
(86) PCT No.: PCT/CN08/00838

§ 371 Date: Dec. 2, 2010

(30) Foreign Application Priority Data
Apr. 24, 2008 (CN) PCT/CN2008/000838

(51) Int. Cl. G06F 3/048

(52) U.S. Cl. 715/760; 715/810

(57) ABSTRACT

One embodiment of the present invention provides a computer-implemented user interface for facilitating a query process. The user interface includes a display mechanism configured to display content to a user. The user interface also includes a selection mechanism configured to allow the user to select at least one displayed area. In addition, the user interface includes a content-analysis mechanism configured to analyze the content in a respective selected displayed area. Moreover, the user interface includes an attribute-retrieval mechanism configured to retrieve one or more attributes associated with the selected displayed area based on the content analysis. The user interface further includes an attribute selection mechanism configured allow the user to select one or more attributes. Furthermore, the user interface includes a query mechanism configured to issue a query based on the selected attributes without the user inputting characters for the query.

### BACKGROUND

1. Field of the Invention

The present invention relates to a user interface for a computer system. More specifically, the present invention provides a system and method for knowledge-based input in a browser.

2. Related Art

One element of a human-machine interface is the mechanism for a user to provide input into a system, such as a computer. The usability of the interface defines the effectiveness of a system, the efficacy of the interaction between a user and the system, and the level of user satisfaction.

Most computer applications accept input from a user and produce a corresponding outcome. For example, a dictionary application receives an input, a word, from a user. The application then conducts a search in the dictionary database and returns pertinent information, such as pronunciation and definition, to the user. Similarly, an Internet browser receives a query (e.g., a keyword or a phrase) from a user, and forwards the query to a search engine. The search engine then searches its records on information available on the Internet and returns to the user a list of URLs. The user can then click on the URLs and retrieve the content from various Internet servers.

The ubiquitous availability of Internet connectivity has made Internet browser one of the most frequently used computer applications. A browser not only serves as a mechanism for viewing web sites, but also functions as a portal to the vast amount of information available on the Internet. In addition, most browsers are enhanced with embedded search tool bars. One can now quickly locate the information he is looking for by typing keywords into a search tool bar within a browser.

In recent years, many mobile devices, such as mobile phones and personal data assistants (PDAs) have also incorporated wireless networking capability and allow a user to log on the Internet at any time. Internet browsers on mobile devices, however, remain fairly difficult to use. This is because it is typically difficult for a user to input characters in an address bar or a search field with the input mechanism on a mobile device (e.g., a keypad or touchscreen).

### SUMMARY

One embodiment of the present invention provides a computer-implemented user interface for facilitating a query process. The user interface includes a display mechanism configured to display content to a user. The user interface also includes a selection mechanism configured to allow the user to select at least one displayed area. In addition, the user interface includes a content-analysis mechanism configured to analyze the content in a respective selected displayed area. Moreover, the user interface includes an attribute-retrieval mechanism configured to retrieve one or more attributes associated with the selected displayed area based on the content analysis. The user interface further includes an attribute selection mechanism configured allow the user to select one or more attributes. Furthermore, the user interface includes a query mechanism configured to issue a query based on the selected attributes without the user inputting characters for the query.

In a variation of this embodiment, the attribute selection mechanism is further configured to present the user with one or more retrieved attributes.

In a variation of this embodiment, the user interface is implemented in a browser.

In a variation of this embodiment, the selected displayed area is highlighted.

In a variation of this embodiment, the selected displayed area contains text, graphics, multimedia information, or a combination of some or all of the above.

In a variation of this embodiment, while allowing the user to select the displayed area, the selection mechanism is configured to allow the user to drag a cursor across the displayed area.

In a variation of this embodiment, while allowing the user to select the displayed area, the selection mechanism is configured to allow the user to select one or more displayed objects; wherein a respective displayed object can be a word, a phrase, graphics, or a video clip.

In a variation of this embodiment, the retrieved attributes include information associated with text, graphics, multimedia, or a combination of some or all of the above.

In a variation of this embodiment, the query mechanism is configured to allow the user to edit the attributes before issuing the search query.

In a variation of this embodiment, the query is an URL and while issuing the query, the query mechanism is configured to plug the selected attributes as an input into the URL.

### BRIEF DESCRIPTION OF THE FIGURES

The drawings accompanying and forming part of this specification are included to depict certain aspects of the invention. The invention may be better understood by reference to one or more of these drawings in combination with the description presented herein. It should be noted that the features illustrated in the drawings are not necessarily drawn to scale.

FIG. 1 illustrates an exemplary mode of operation of a mobile user obtaining information from an Internet server, in accordance with one embodiment of the present invention.

FIG. 2 illustrates the components of a computer-implemented user interface that facilitates knowledge-based browser input, in accordance with one embodiment of the present invention.

FIG. 3 presents a set of exemplary screenshots illustrating the operation of knowledge-based input in a browser, in accordance with one embodiment of the present invention.

FIG. 4 is a flow chart illustrating a method to facilitate a query process by a computer-implemented user interface in accordance with one embodiment of the present invention.

FIG. 5 illustrates a computer system containing a computer-implemented user interface in accordance with one embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the present invention. Thus, the present invention is not limited to the embodiments shown, but is to be accorded the widest scope consistent with the appended claims.

Embodiments of the present invention provide a user interface that facilitates knowledge-based user input. A computing device equipped with this user interface can allow a user to generate a query without explicitly entering characters for the query. In one embodiment, the user can select one or more areas of interest on the display. The system then analyzes the content in the selected area, and extracts attributes (such as text) from the content. The user can then select one or more attributes which are subsequently used by the system to compose the query. In addition, the system can automatically forward the selected attributes as input to another application, thereby obviating the need for the user to manually inputting information to that application.

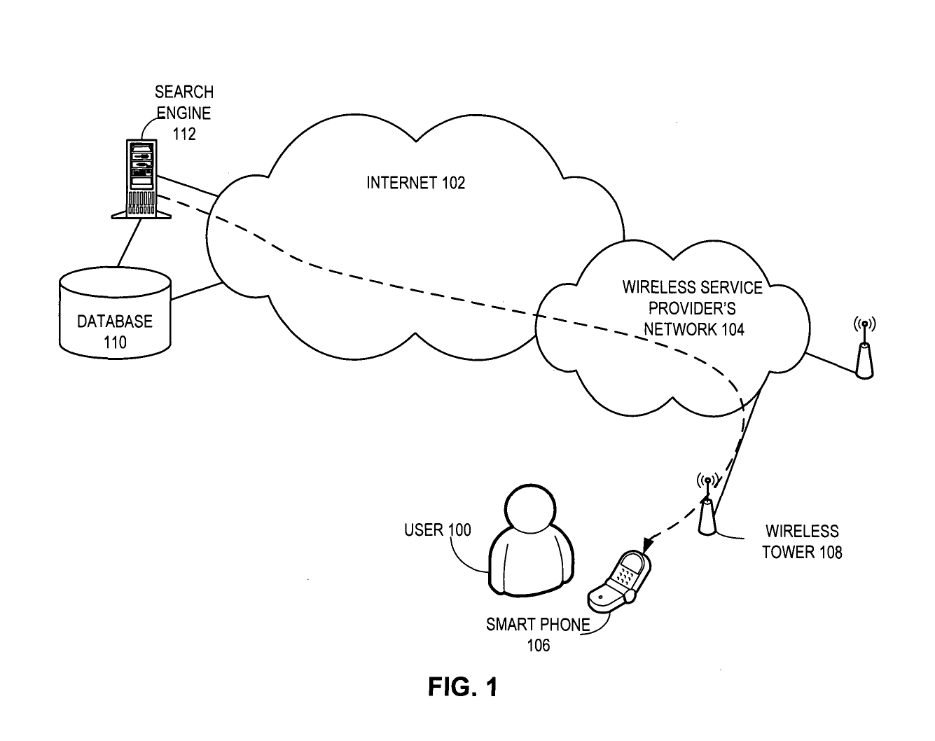

FIG. 1 illustrates an exemplary mode of operation of a mobile user obtaining information from an Internet server, in accordance with one embodiment of the present invention. Mobile user 100 browses a Web page on his mobile device, such as a smart phone 106. User 100 identifies some content displayed on smart phone 106, and highlights the interesting content using, for example, a stylus or his finger on the touchscreen of smart phone 106. Smart phone 106 then analyzes the highlighted content and extracts words from this content. Subsequently, smart phone displays a list of extracted words, whereby user 100 can select one or more extracted words by tapping on the words.

Next, smart phone can compose a search query using the words selected by the user and communicate the query to search engine 112. The query is first transmitted to a wireless tower 108 of a wireless service provider. The query then traverses the wireless service provider's network 104 and the Internet 102, and reaches Internet server 112. Internet server 112 processes the query and searches a database 110. Information containing the result of the search is subsequently returned to smart phone 106 of mobile user 100. In some embodiments, Internet server 112 can be a search engine such as Google or Yahoo, and the information returned from Internet server 112 is a list containing a number of URLs. In other embodiments, Internet server 112 can be a content provider, such as an online encyclopedia, a wiki site, or a multimedia server, and the information returned can a page containing text, graphics, and/or multimedia streams. Mobile user 100 can continue to explore and retrieve information from Internet server 112 following the receipt of the information.

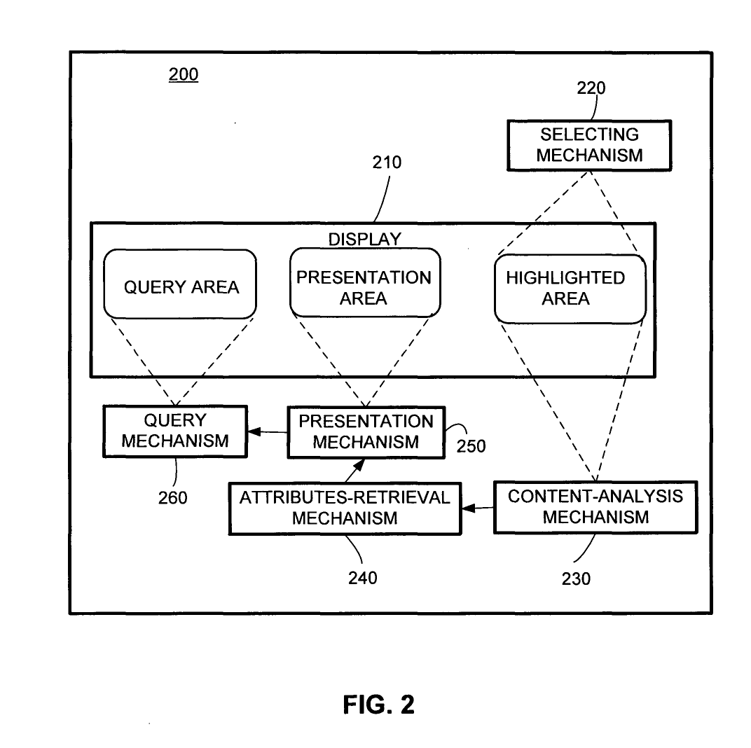

FIG. 2 illustrates the components of a computer-implemented user interface 200 that facilitates knowledge-based browser input, in accordance with one embodiment of the present invention. In this example, user interface 200 includes a display 210, a selection mechanism 220, a content-analysis mechanism 230, an attribute-retrieval mechanism 240, a presentation mechanism 250, and a query mechanism 260. In one embodiment, user interface 200 can be implemented in an Internet browser.

Display 210 can be a touchscreen or a conventional non-interactive screen. Selection mechanism 220 can include a selection device such as a light pen, trackball, mouse, trackpoint, touchpad, keypad, keyboard, or the user's finger. In one embodiment where display 210 is a touchscreen, the user can drag the pointing device across the displayed area to highlight the areas of interest. The user can also use conventional selection devices such as keyboard, mouse, or trackpoint to select the displayed area of interest. Regardless of the type of display 210, the selected area can be of a regular or irregular shape. In one embodiment, the selected area is highlighted so that he user can see what has been selected.

Content-analysis mechanism 230 then processes the content of the highlighted area, which can contain text, graphics, multimedia data, or a combination of some or all of the above. In one embodiment, content-analysis mechanism 230 first determines what type of content, e.g., text, graphics, multimedia, etc., the selected area contains.

In one embodiment, when the selected content contains text, attribute-retrieval mechanism 240 parses the words and phrases in the text to extract a set of keywords. When the selected content contains graphics, attribute-retrieval mechanism 240 analyzes the graphics to extract a set of attributes, such as size, creation time, file type, and places and/or persons in the graph. When the selected content contains multi-media streams, attribute-retrieval mechanism 240 analyzes the streams to extract a set of associated attributes, such as the length, production date, main theme, meta data, etc., of the streams.

Presentation mechanism 250 displays the set of attributes extracted by attribute-retrieval mechanism 240 on display 210 and then solicits input from the user. Note the term “attribute” here can refer to plain text extracted from the content and/or other information pertaining to the content. The set of attributes can be displayed in a text, graphic, multimedia, or a combined format. The user makes a selection through selection mechanism 220.

After the user selects the attributes, query mechanism 260 forwards the selected attributes to a query area. Note that the term “query” here is used in a broad sense, and can refer to any input to an application. For example, a query can be a URL input in a Web browser's address bar. A query can also be a search logic input to a search tool bar or a search field in a search-engine portal page. Furthermore, the system can allow the user to configure what type of input the query is. For example, the user can configure the system so that the selected attributes are used to generate an entry to an online encyclopedia or a local dictionary application. The user can also configure the system so that the attributes are used to form part of an URL which is subsequently used in the browser to load a particular web page. In some embodiments, query mechanism 260 allows the user to edit the attributes (e.g., keywords) before it issues a query.

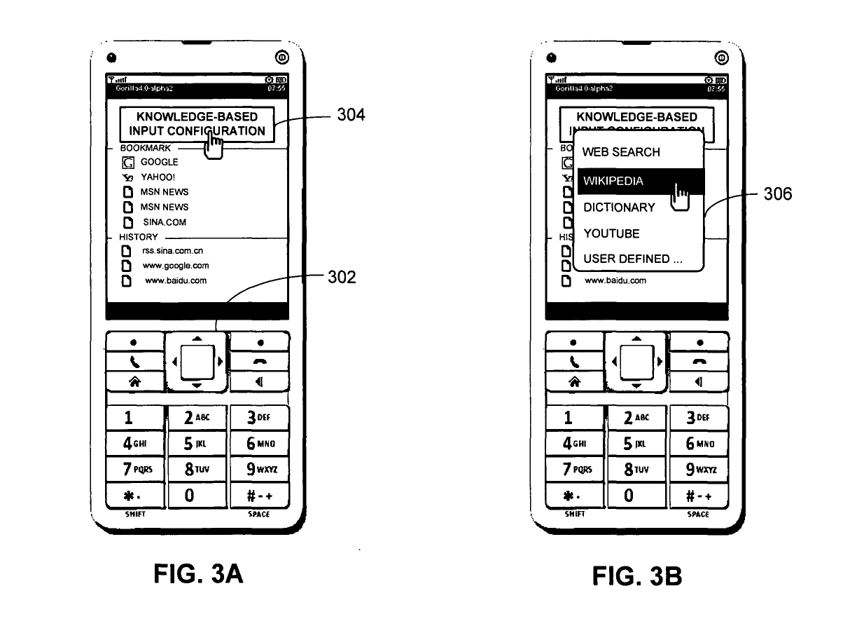

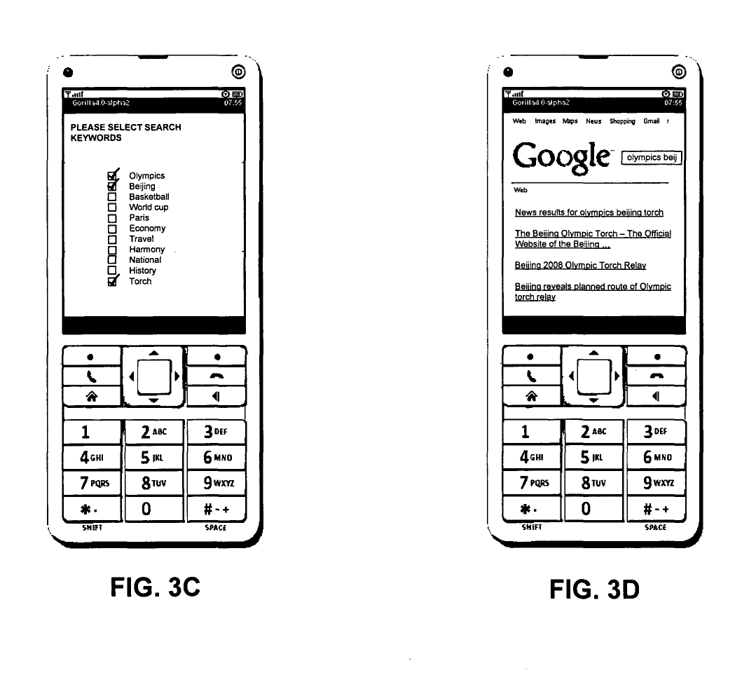

FIG. 3 presents a set of exemplary screenshots illustrating the operation of knowledge-based input in a browser, in accordance with one embodiment of the present invention. In the example shown in FIG. 3A, a smart phone displays a configuration screen that allows the user to configure the device as to what application will be taking the input generated from the attributes which are extracted from user-selected content. In one embodiment, the user can use the smart phone's navigation key 302 to select and click a configuration button 304. After the click, the system then activates a configuration menu which is illustrated in FIG. 3B. Note that the screen in FIG. 3A also displays a set of bookmarks and past websites that the user has visited to facilitate the configuration process.

As shown in FIG. 3B, upon the user clicking configuration button 304, the system displays a configuration menu 306. Menu 306 lists a number of websites and applications that can take as inputs attributes extracted from user selected content. In this example, the user selects wikipedia as the destination for the query. In one embodiment, the system can also allow the user to define other applications to take the input.

When the smart phone displays content, for example a web page, the user can use the navigation key or other selection mechanism (such as a stylus or finger on the touchscreen) to select some content on the display. The system can then extract the attributes of the selected content and allow the user to choose from these attributes. The selected attributes are then used to generate the input, such as a query, to a search engine or another application. In one embodiment, the user can drag across the display to select content. The user can also use a key on the keypad to select text, graphics, or multimedia files.

As illustrated in FIG. 3C, in one embodiment, the display can present a list of keywords extracted from the user-selected content. The user can select one or more keywords. Next, as illustrated in FIG. 3D, the browser can form a search query based on the keywords selected by the user and transmit the query to a search engine. This way, the user can have easy access to the information of interest without explicitly typing in the keywords. This input method is particularly valuable on mobile devices, because it is often difficult for the user to input characters, either by punching the keypad or by writing on the touchscreen.

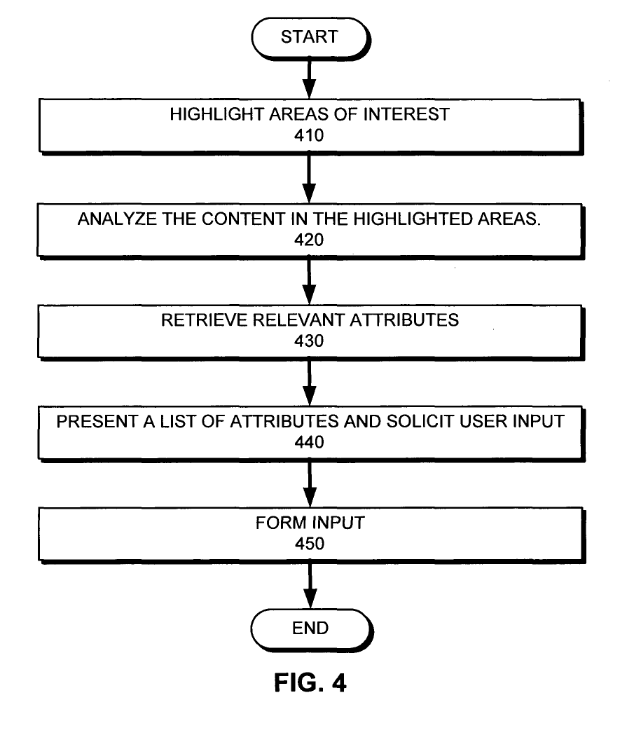

FIG. 4 is a flow chart illustrating a method to facilitate a query process by a computer-implemented user interface in accordance with one embodiment of the present invention. During operation, a user first activates an application, such as a Web browser, and reads the content displayed on the screen. The user then highlights the areas of interest using a selection mechanism (operation 410). If the display is a touchscreen, the selection mechanism can be a pointing device such as a stylus, track ball or user's finger. The user can drag the cursor across the displayed area to highlight a region, which can be of a regular or irregular shape. If the display is a conventional non-interactive screen, the selection mechanism can be a keyboard, a mouse, or any type of input device for a computer or a mobile device.

The highlighted area can contain text, graphics, multimedia data, or a combination of some or all of the above. A content-analysis mechanism then processes the content of the highlighted area (operation 420). The content-analysis mechanism subsequently determines what type of content the user has selected.

Next, an attribute-retrieval mechanism analyzes the information contained in the highlighted area based on its corresponding content type, and retrieves relevant attributes (operation 430). For a textual content, the attribute-retrieval mechanism parses the words and phrases to generate a set of keywords. For graphic content, the attribute-retrieval mechanism analyzes the graphics to generate a set of attributes related to the file or the content of the graphics. As to multimedia content, the attribute-retrieval mechanism can analyze audio and video streams to generate a set of associated attributes, such as the names of songs and characters in the audio streams.

Subsequently, a presentation mechanism presents the user with a list of relevant attributes generated by the content-analysis mechanism (operation 440). The attributes can be displayed in a text, graphics, multimedia, or a combined format. In addition, the presentation mechanism solicits input from the user regarding his or her attributes of interest. Subsequently, the user makes a selection through a selection mechanism.

Once the selection is made, an input mechanism forms an input based on the attributes selected by the user (operation 450). Note that the input mechanism allows the user to edit the attributes (e.g., keywords) before it forms the input. In some embodiments, the input mechanism can form a URL based on the user-selected attributes and use the input as an entry of a Web browser, such as Internet Explorer or Firefox. It can also forward the input to an application for further processing. For example, the input mechanism can forward the input to a dictionary program to search for the definition of a word or phrase.

Although the description above is mostly directed to mobile devices, embodiments of the present invention can also be applied to a variety of computing environments. For example, the present input method can be implemented in a Web browser on a desktop or laptop computer. Furthermore, embodiments of the present invention are not limited to the implementation within browsers. Any application that displays content can be enhanced by the present knowledge-based input method. For example, this input method can be incorporated in a word processor, wherein the user can easily select displayed words and use the user interface to automatically generate search queries. Similar enhancements can be made to other applications, such as email programs and news readers. In addition, embodiments of the present invention are not limited to a particular language. The aforementioned input method can be used with a variety of languages, which include but are not limited to western languages such as English, French, German, Spanish, and Russian, and eastern languages such as Chinese, Japanese, and Korean.

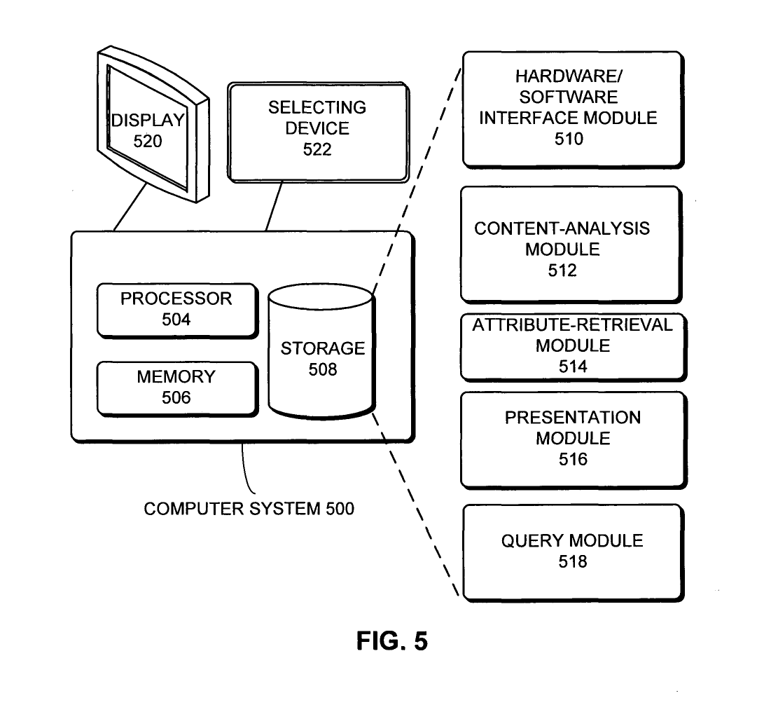

FIG. 5 illustrates a computer system 500 containing a computer-implemented user interface in accordance with one embodiment of the present invention. Computer system 500 comprises a processor 504, a memory module 506, and a storage device 508. Computer system 500 is also coupled to a display 520 and a selection device 522. Storage device 508 stores a number of applications, which includes modules for implementation the user interface as described above. In one embodiment, storage device 508 stores a hardware/software interface module 510, a content-analysis module 512, an attribute-retrieval module 514, a presentation module 516, and a query module 518. Display 520 and selection device 522 can be configured in computer system 500 in at least two ways: to be assembled with the rest of the components in a unitary housing, such as a smart phone, or to be connected to the rest of the components in a unitary housing via wired or wireless means.

During operation, hardware/software interface module 510, content-analysis module 512, attribute-retrieval module 514, presentation module 516, and query module 518 are loaded from storage device 508 into memory 506 and executed by processor 504 to implement a user interface that facilitates knowledge-based input as described above.

The invention is illustrated with different embodiments, described in detail, and with examples for purposes of facilitating the implementation of the different features or components of the invention. However, it is not the intent of the inventors to limit the application of the invention to the details shown. Modification of the features or components of the invention can be made without deviating from the spirit of the invention and thus still remains within the scope of the appended claims.

What is claimed is:

1. A computer-implemented user interface for facilitating a query process, the user interface comprising:
a display mechanism configured to display content to a user;
a selection mechanism configured to allow the user to select at least one displayed area;
a content-analysis mechanism configured to analyze the content in a respective selected displayed area;
an attribute-retrieval mechanism configured to retrieve one or more attributes associated with the selected displayed area based on the content analysis;
an attribute selection mechanism configured to allow the user to select one or more attributes; and
a query mechanism configured to issue a query based on the selected attributes without the user inputting characters for the query.

2. The user interface of claim 1, wherein the attribute selection mechanism is further configured to present the user with one or more retrieved attributes.

3. The user interface of claim 1, wherein the user interface is implemented in a browser.

4. The user interface of claim 1, wherein the selected displayed area is highlighted.

5. The user interface of claim 1, wherein the selected displayed area contains text, graphics, multimedia information, or a combination of some or all of the above.

6. The user interface of claim 1, wherein while allowing the user to select the at least one displayed area, the selection mechanism is configured to allow the user to drag a cursor across the displayed area.

7. The user interface of claim 1, wherein while allowing the user to select the at least one displayed area, the selection mechanism is configured to allow the user to select one or more displayed objects; and wherein a respective displayed object can be a word, a phrase, graphics, or a video clip.

8. The user interface of claim 1, wherein the retrieved attributes include information associated with text, graphic, multimedia, or a combination of some or all of the above.

9. The user interface of claim 1, wherein the query mechanism is configured to allow the user to edit the attributes before issuing the search query.

10. The user interface of claim 1, wherein the query is an URL and wherein while issuing the query, the query mechanism is configured to plug the selected attributes as an input into the URL.

11. A method for facilitating a query process by using a computer-implemented user interface, the method comprising:
displaying content to a user;
allowing the user to select at least one displayed area;
analyzing the content in a respective selected displayed area;
retrieving one or more attributes associated with the selected displayed area based on the content analysis;
allowing the user to select one or more attributes; and
issuing a query based on the selected attributes without the user inputting characters for the query.

12. The method of claim 11, wherein allowing the user to select one or more attributes comprises presenting the user with one or more retrieved attributes.

13. The method of claim 11, wherein the user interface is implemented in a browser.

14. The method of claim 11, wherein the selected displayed area is highlighted.

15. The method of claim 11, wherein the selected displayed area contains text, graphics, multimedia information, or a combination of some or all of the above.

16. The method of claim 11, wherein allowing the user to select the displayed area comprises allowing the user to drag a cursor across the displayed area.

17. The method of claim 11, wherein allowing the user to select the displayed area comprises allowing the user to select one or more displayed objects; and wherein a respective displayed object can be a word, a phrase, graphics, or a video clip.

18. The method of claim 11, wherein the retrieved attributes include information associated with text, graphics, multimedia, or a combination of some or all of the above.

19. The method of claim 11, further comprising allowing the user to edit the attributes before issuing the search query.

20. The method of claim 11, wherein the query is a URL and wherein the method further comprises plugging the selected attributes as an input into the URL.

21. A computer-readable medium encoded with instructions which when executed by a computer cause the computer to perform a method for facilitating a query process by using a computer-implemented user interface, the method comprising:
displaying content to a user;
analyzing the content in a respective selected displayed area;
retrieving one or more attributes associated with the selected displayed area based on the content analysis;
allowing the user to select one or more attributes;
issuing a query based on the selected attributes without the user inputting characters for the query.
